(19) United States
(12) Patent Application Publication
(10) Pub. No.: US 2025/0258668 A1
(43) Pub. Date: Aug. 14, 2025

(54) APPLICATION SETTING SHARING

(71) Applicant: International Business Machines Corporation, Armonk, NY (US)

(72) Inventors: Soumya Yernad SHANTHIMOHAN, Bangalore (IN); Sandhya SUMAN, Bengaluru (IN); Smitha TV, Bangalore (IN); Vijay EKAMBARAM, Bangalore (IN)

(21) Appl. No.: 18/442,083

(22) Filed: Feb. 14, 2024

(51) Int. Cl. G06F 8/71; G06F 8/61; H04L 9/30; H04L 51/18

(52) U.S. Cl. CPC G06F 8/71; G06F 8/61; H04L 9/30; H04L 51/18

(57) ABSTRACT

A first user device may receive an indication of a set of application settings from a second user device. The application settings may be associated with a user application that is downloaded and installed by the user as an optional application of the first user device. In some implementations, the application settings may include user preference settings, such as privacy settings, display settings, interface settings. In some implementations, the first user device may perform one or more operations to verify the second user device and process a message that includes the indication of the application settings. In some implementations, the second user device may transmit the indication of the application settings based on receiving a request from the first user device.

### BACKGROUND

The present invention relates to application settings of an application executing on a user device. The present invention may operate on user devices, such mobile devices. Applications for computing devices may be configurable with selectable settings. For example, a user may configure a social media application on a user device with privacy settings (e.g., who can see posts), access settings (e.g., what times of day a user is permitted to use the social media application), feed interest settings, volume settings, or font settings, among other examples. The application may include a downloaded application, other applications that are not factory installed, or an application without privilege permissions.

### SUMMARY

In some implementations, a computer-implemented method performed by a first user device includes receiving, from a second user device, a message comprising an indication of one or more settings associated with an application executable by the first user device. In some implementations, the computer-implemented method may include configuring the application based on the one or more settings.

In some implementations, a computer program product comprises one or more computer readable storage media, and program instructions collectively stored on the one or more computer readable storage media. The program instructions comprise program instructions to receive, at a first user device and from a second user device, a short message service (SMS)-based message comprising an indication of one or more settings associated with an application executable by the first user device, the SMS-based message secured using a security key associated with the second user device. The program instructions further comprise program instructions to configure the application based on the one or more settings.

In some implementations, a system comprises one or more devices configured to: receive, at a first user device and from a second user device, a message comprising an indication of one or more settings associated with an application executable by the first user device, wherein the message comprises a hash of the one or more settings that is signed with a private key associated with the second user device. The one or more devices are further configured to validate that the message is associated with the second user device. The one or more devices are further configured to configure, at the first user device, the application based on the one or more settings.

### BRIEF DESCRIPTION OF THE DRAWINGS

FIGS. 1A-1F are diagrams of an example implementation described herein.

FIG. 2 is a diagram of an example computing environment in which systems and/or methods described herein may be implemented.

FIG. 3 is a diagram of example components of one or more devices of FIGS. 1 and 2.

FIG. 4 is a flowchart of an example process associated with sharing application settings.

### DETAILED DESCRIPTION

The following detailed description of example implementations refers to the accompanying drawings. The same reference numbers in different drawings may identify the same or similar elements.

A user may not be tech-savvy, may not understand effects of settings, may have vision impairment, may be a dependent, or may want to avoid time and effort associated with configuring settings for an application of a user device. In these cases, an assistant may provide direct input to the user device to assist the user in configuring application on the user device. However, in some of these cases, the assistant may be far away from user device. Alternatively, the assistant may provide instructions to the user and the user may provide direct input to the user device to configure the application on the user device. However, the user would still provide time and effort to configure the application for the user device. Additionally, or alternatively, the user device may consume computing or power resources based on receiving incorrect inputs from the user or changing the settings multiple times unnecessarily based on errors, or may provide a poor user experience to the user based on being misconfigured.

In some implementations described herein, a first user device may receive an indication of application settings from a second user device. In some implementations, the first user device may accept the indication of the application settings from the second user device based on the second user device being a known device to the first user device. For example, the first device may identify the second device as a known device based on a phone number associated with the second device, a medium access control (MAC) address, or other device identifier (ID), among other examples.

In some examples, the indication of the application settings may be an indication of the application settings as configured on the second user device. Alternatively, the second user device may identify a set of application settings to provide to the first user device. For example, the second user device may receive an indication of a selection of the set of application settings to provide to the first user device, and may provide the indication of the application settings based on the selection.

In some implementations, the first user device may receive the indication of the application settings from the second user device rather than from an application server or application owner. In this way, the first user device may receive the indication of the settings as a set of settings that has an increased likelihood of satisfying a desire of a user of the first user device than a generic set of settings from an application owner, which may be configured to benefit the application owner rather than the user. For example, settings pushed by the application owner may allow for sharing of unwanted information based on increased sharing of information increasing content associated with the application or increasing a possibility of selling the unwanted information.

In some implementations, the first user device and the second user device may be configured with an application plugin (e.g., an in-app plugin) that supports sharing of application settings. For example, the application plugin may provide an interface for exporting an indication of the application settings as configured on the second user device or may provide an interface for receiving the application settings and applying the application settings to the application at the first user device.

In some implementations, the second user device may encode and encrypt an indication of the application settings or a message that includes the indication. The second user device may transmit the message to the first user device. For example, the second user device may transmit the message using a direct communication link with the first user device (e.g., via a personal area network (PAN) link or a local area network (LAN) link, among other examples). In some examples, the second user device may transmit the message using a telecommunication network. For example, the message may include a short message service (SMS)-based message, a multimedia messaging service (MMS)-based message, or a rich text format (RTF)-based message.

If the second user device encoded or encrypted the message or the indication, the first user device may decode and decrypt the message or indication. The first user device may then apply the settings to the application at the first user device.

In some implementations, the second user device may provide the indication of the application settings based on the first user device transmitting a request for the application settings to the second user device.

In some implementations, the application plugin associated with the application at the second user device may listen to the request. The second user device (e.g., via the application plugin) may encode a current or selected application settings, sign the encoded application settings with a private key, or create a hash or other encoding or encryption of the signed encoded application settings.

In some implementations, the second user device may transmit an indication of the application settings. For example, the second user device may transmit the indication as the hash or other encoding or encryption of the application settings (e.g., signed and encoded application settings). In some implementations, the second user device may transmit the indication of the application settings via a direct link or a telecommunication network.

In some implementations, the first user device may receive the message that includes the indication of the settings and provide the message to the application. For example, the application plugin may listen to the message, validate an originator or source of the message (e.g., the second user device), or upload the encoded message content, among other examples. In some implementations, the first device (e.g., via the application plugin) may decode the message, extract a public key from the message, extract the settings (e.g., still encrypted), decrypt the message based on the public key, or apply the application settings after successful decryption, among other examples.

In some implementations, the application settings indicated in the message may include application settings that are modified from current settings of the application on the second user device. In some aspects, only non-secure application settings may be indicated in the message. In some implementations, only application settings that do not indicate a user's private or secure data may be indicated in the message. In some aspects, a server or network node may facilitate a client-client transfer of the application settings.

In some aspects, before initiating a transfer of the indication of the application settings, the first user device may identify the second user device as a trusted device. For example, the first user device may receive input from a user that indicates trust of the second user device, or the first user device may determine trust for the second user device based on the second user device being associated with a contact list of the first user device. In some examples, the second user device may be associated with a phone number in a contact list of the first device, which the first device may use as an indication of trust of the second user device for receiving application settings.

In some implementations, the first user device may receive the message based on a request for the application settings, rather than based on an update to the application pushed from the application server. In some implementations, the second user device may transmit the indication of the application settings or an update to the application settings according to input from a user to the first user device or based on an update of the application settings for the application at the second user device, among other examples. For example, the second user device may transmit a settings update that is initiated at any point of time, multiple times a day, or depending on a need of the first user device or of a user associated with the first user device.

An advantage of supporting sharing of application settings between user devices is to enable a user device to provide an improved user experience. An additional advantage is to conserve computing and power resources that may have otherwise been consumed during attempts to configure settings for the application at the user device.

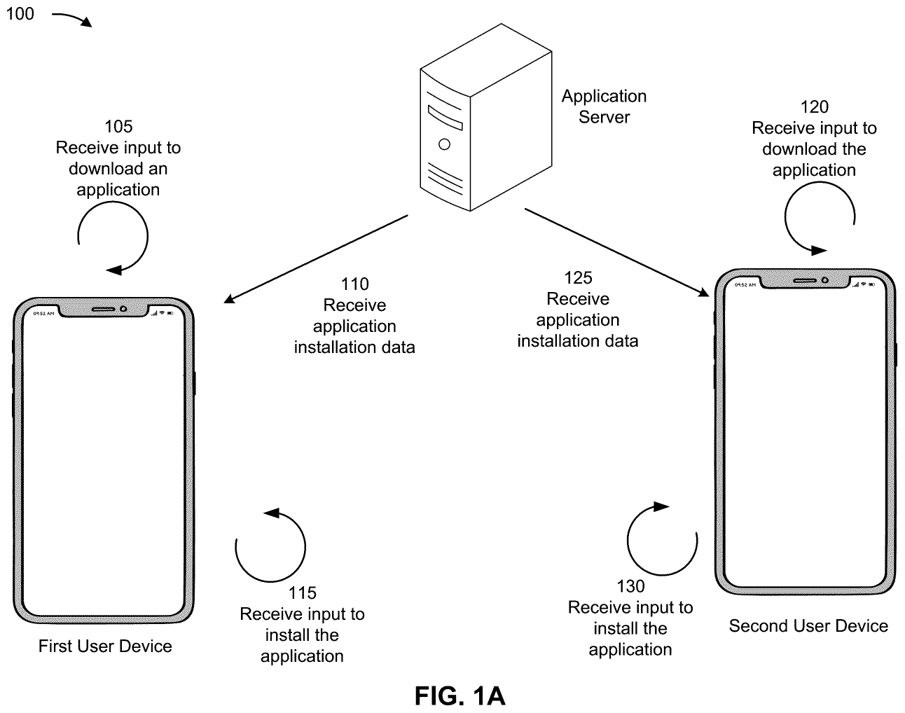

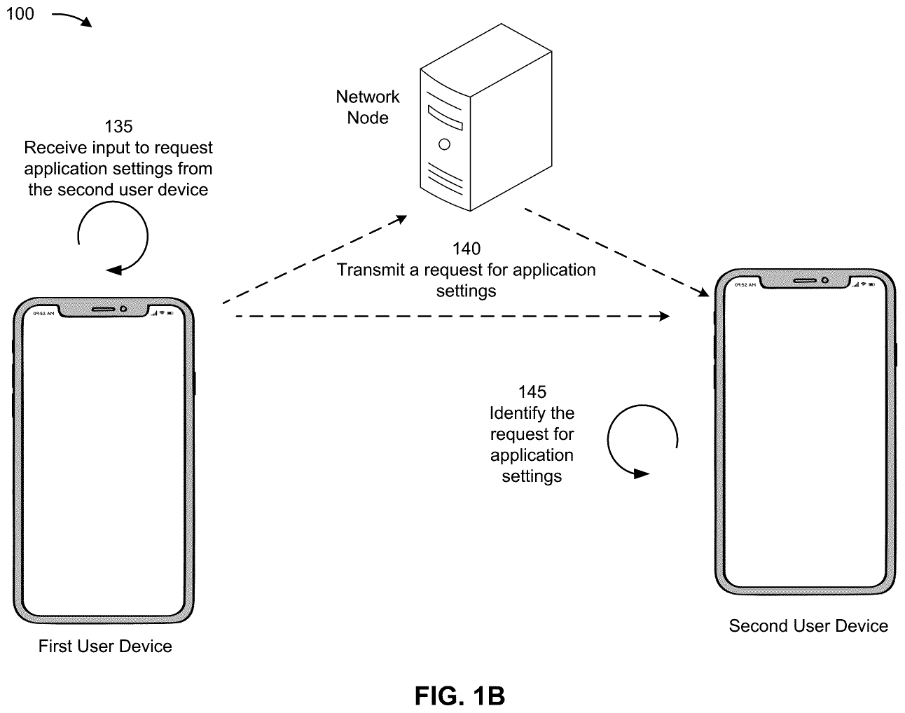

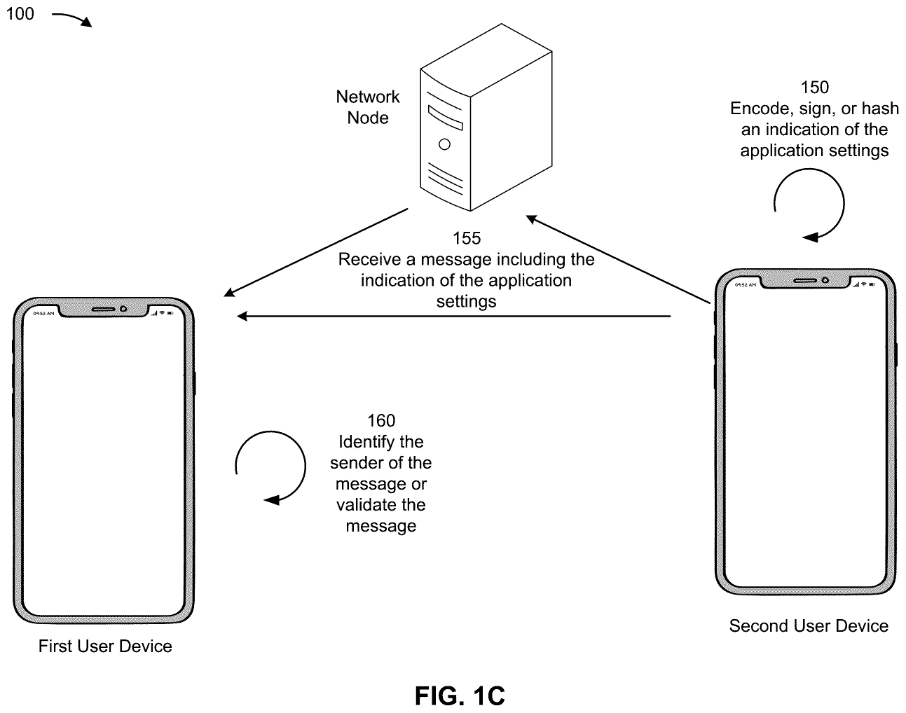

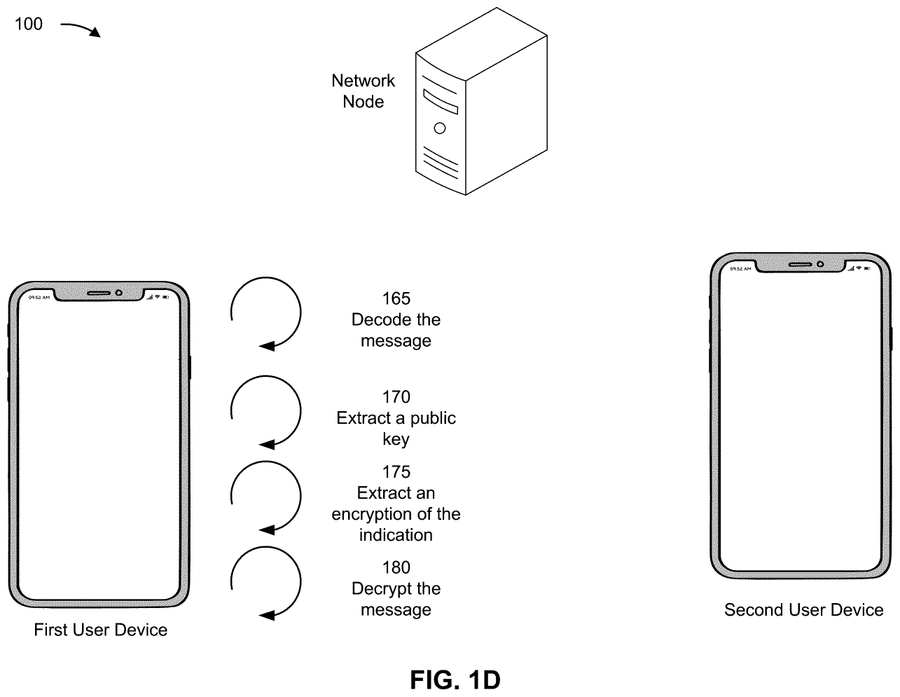

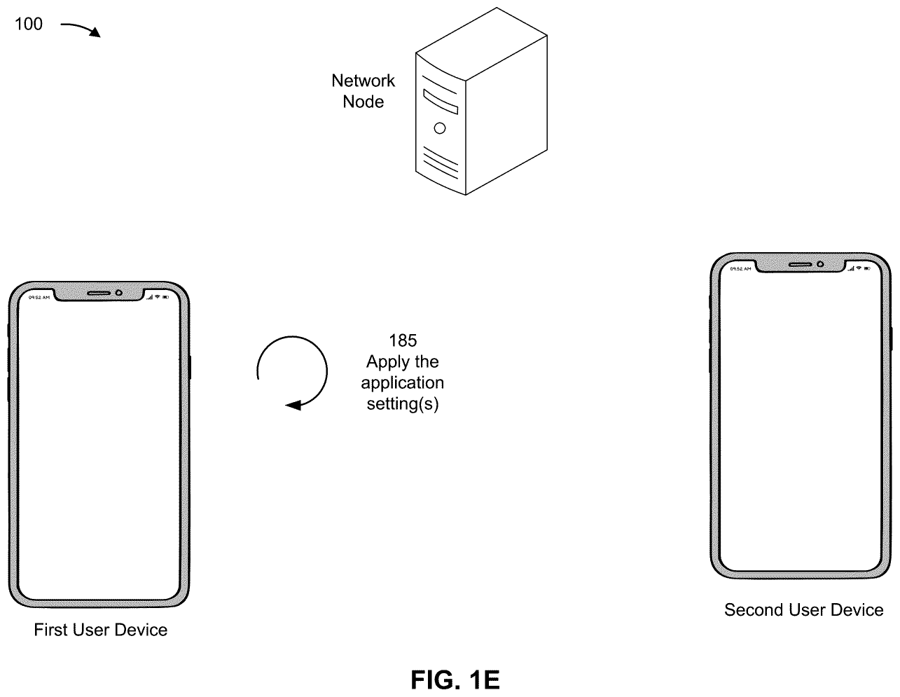

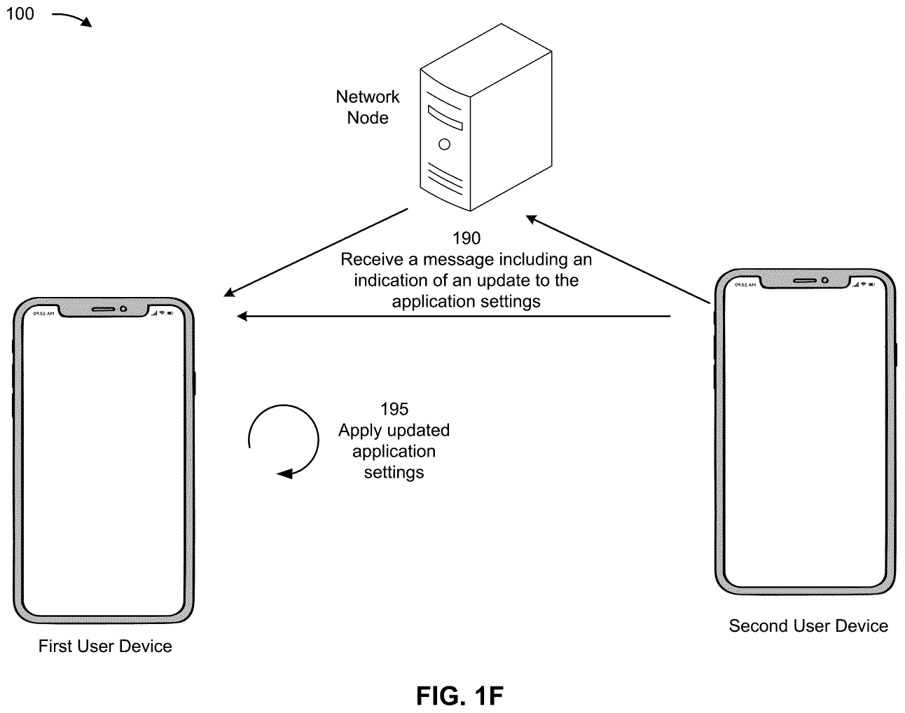

FIGS. 1A-1F are diagrams of an example implementation 100 described herein. As shown in FIGS. 1A-1F, example implementation 100 includes a first user device and a second user device that are configured to communicate via a communication link. The communication link may include a direct connection or may be facilitated by a network node.

As shown in FIG. 1A, and by reference number 105, the first user device may receive input to download an application. For example, the first user device may receive the input via an input/output interface through which the first user device receives input from a user. Additionally, or alternatively, the first user device may receive the input from another device, such as the second user device or an application server. The application server may be a server device.

The application may not be an operating system factory application. For example, the application may be a consumer application, such as a social media application, a gaming application, a productivity application (e.g., word processing, business intelligence, drawing, or data collection, among other examples), a media application (e.g., videos, music, sports, politics, or news, among other examples), or other type of optional application that is not part of the operating system or needed to operate the first user device, among other examples.

As shown by reference number 110, the first user device may receive application installation data from an application server. In some implementations, the first user device may receive the installation data based on transmitting a request for the application installation data. For example, the first user device may receive input via an application store accessible via the first user device. The input may select the application for downloading from the application server.

Additionally, or alternatively, the first user device may receive the application installation data independently from (e.g., in the absence of) the input described in connection with reference number 105. For example, the application server may provide the application installation data to the first user device based on receiving a request to provide the application installation data from the second user device or another device.

As shown by reference number 115, the first user device may receive input to install the application. For example, the first user device may receive user input that indicates approval to install the application. In some implementations, the input described in connection with reference number 115 may be the same as the input described in connection with reference number 105. Alternatively, the first user device may receive the input to install the application based on receiving the application installation data as a recommendation from another device, such as the second user device.

Based on the input to install the application, the first user device may use the application installation data to install the application with a set of settings. For example, the set of settings may include default settings, initially selected settings, or settings that are based on a location of the first user device (e.g., a selected language or privacy setting, among other examples), among other examples.

As shown by reference number 120, the second user device may receive input to download the application, similar to the operation described in connection with reference number 105. For example, the second user device may receive the input from a local user or may receive the input from a remote user or other computing device. In some implementations, the input may be associated with the first user device or a request for the second user device to provide an indication of settings for the application.

As shown by reference number 125, the second user device may receive the application installation data from the application server. In some implementations, the second user device may receive the application installation data before or after the first user device receives the application installation data.

As shown by reference number 130, the second user device may receive input to install the application, similar to the operation described in connection with reference number 115. The second user device may install the application based on the input. The second user device may receive inputs to select settings for the application. For example, the application may be configurable with customized settings, which may be selected by a user of the second user device or another source.

As shown in FIG. 1B, and by reference number 135, the first user device may receive input to request application settings (e.g., one or more settings associated with the application) from the second user device. For example, the first user device may receive local input from a user to request application settings from the second user device. In some implementations, the first user device may receive the input of reference number 135 based on the second user device transmitting an invitation to receive the settings to the first user device.

In some implementations, the request may identify the second user device via a device ID. For example, the device ID may include a phone number, a MAC address, or other identifier associated with the second user device. In some implementations, the first user device may use an application plugin associated with the application to generate the request for the application settings. In some implementations, the first user device may use an independent application configured to request application settings for other applications of the first user device.

As shown by reference number 140, the first user device may transmit, and the second user device may receive, a request for application settings. In some implementations, the first user device may transmit the request via a network node (e.g., via a telecommunications network, a local area network router, or other network node, among other examples). In some implementations, the first user device may transmit the request via a direct link (e.g., a personal area network link or a sidelink interface, among other examples).

As shown by reference number 145, the second user device may identify the request for application settings. For example, the second user device may identify an application for which the settings are requested, the first user device as the requesting device, or a user of the user device, among other examples. In some implementations, the second user device may request input from a user to accept the request before generating a response to the request.

As shown in FIG. 1C, and by reference number 150, the second user device may encode, sign, or hash an indication of the application settings. For example, second user device may perform one or more of encoding, signing, or hashing the indication to provide security to the indication, reduce a payload size of a message that includes the indication, or improve reception of the indication, among other examples.

As shown by reference number 155, the first user device may receive, and the second user device may transmit, a message including the indication of the application settings. Similar to the transmission described in connection with reference number 140, the second user device may transmit the message via a network node or via a direct link with the first user device.

As shown by reference number 160, the first user device may identify the sender of the message or otherwise validate the message. For example, the first user device may identify a phone number or other device ID associated with the message to identify the sender. In some implementations, the first user device may determine whether to trust the message based on the sender being associated with a list of trusted senders. For example, the first user device may be configured with a set of trusted senders for receiving settings. In some implementations, the first user device may compare the phone number or other device ID to the set of trusted senders to validate the message as a trusted message.

As shown in FIG. 1D, and as shown by reference number 165, the first user device may decode the message. For example, the first user device may decode signaling that carried the message to the first user device.

As shown by reference number 170, the first user device may extract a public key from the message. In some implementations, this may be included with, or associated with, identifying the sender of the message or otherwise validating the message. For example, the first user device may extract the public key in connection with a phone number or other device ID associated with the second user device.

As shown by reference number 175, the first user device may extract an encryption of the indication. For example, the payload of the message, which includes the indication of the settings, may be encrypted using a key. The key may be the public key or a private key that is associated with the public key. In some implementations, the first user device and the second user device may establish the key (e.g., a decryption key) such that the second user device may use the key to decrypt the message.

As shown by reference number 180, the first user device may decrypt the message. In this way, the first user device may identify the application settings indicated by the second user device for sharing with the first user device. In some implementations, the message may include a uniform resource identifier (URI) that includes information identifying the application settings. For example, the message may include a uniform resource locator (URL) that includes information identifying the application settings. As an example, the URL may include a tiny URL.

As shown in FIG. 1E, and by reference number 185, the first user device may apply the application settings indicated in the message. In some implementations, the first user device may use a plugin associated with the application or may use an independent application to receive the one or more settings from a communication component of the first user device and configure the application with the application settings.

In this way, the first user device may be configured with application settings that are configured by the second user device. The application settings may have an increased likelihood of providing an improved user experience relative to default settings of the application. Additionally, or alternatively, the first user device may conserve power and computing resources that may have otherwise been consumed by receiving attempts to configure the settings at the first user device by a user of the first user device.

As shown in FIG. 1F, and by reference number 190, the first user device may receive, and the second user device may transmit, a message including an indication of an update to the application settings. In some implementations, the second user device may transmit the message based on the second user device being reconfigured with updated application settings associated with the application. In some implementations, the second user device may transmit the message based on receiving a request for the update to the application settings.

As shown by reference number 195, the first user device may apply the updated application settings. For example, the first user device may perform one or more operations described in connection with reference numbers 160-185 to apply the updated application settings to the application.

As indicated above, FIGS. 1A-1F are provided as an example. Other examples may differ from what is described with regard to FIGS. 1A-1F. The number and arrangement of devices shown in FIGS. 1A-1F are provided as an example. A network, formed by the devices shown in FIGS. 1A-1F may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

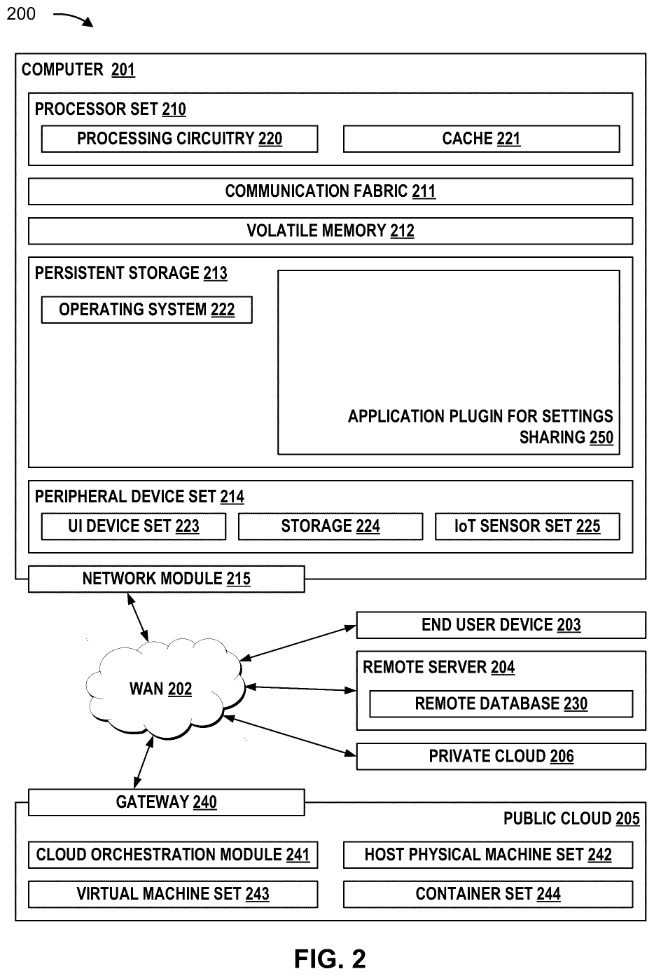

FIG. 2 is a diagram of an example computing environment 200 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as application plugin for settings sharing 250. In addition to application plugin for settings sharing 250, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and application plugin for settings sharing 250, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in application plugin for settings sharing 250 in persistent storage 213.

Communication fabric 211 is the signal conduction path that allows the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in application plugin for settings sharing 250 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201) and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

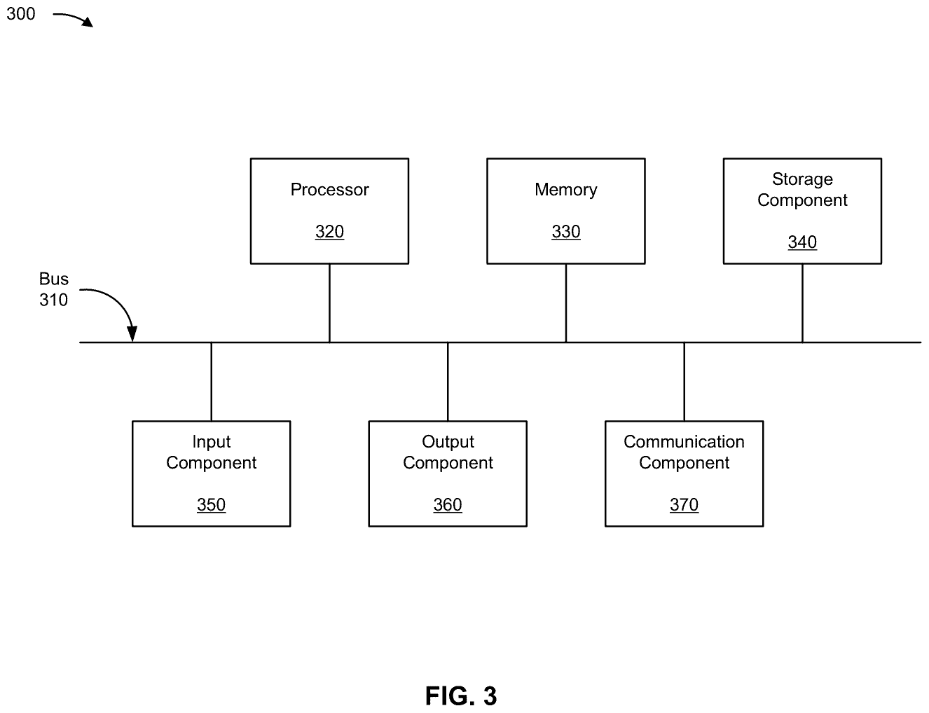

FIG. 3 is a diagram of example components of a device 300, which may correspond to the first user device, the second user device, the application server, or the network node. In some implementations, the first user device, the second user device, the application server, or the network node may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may be a repository that stores a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

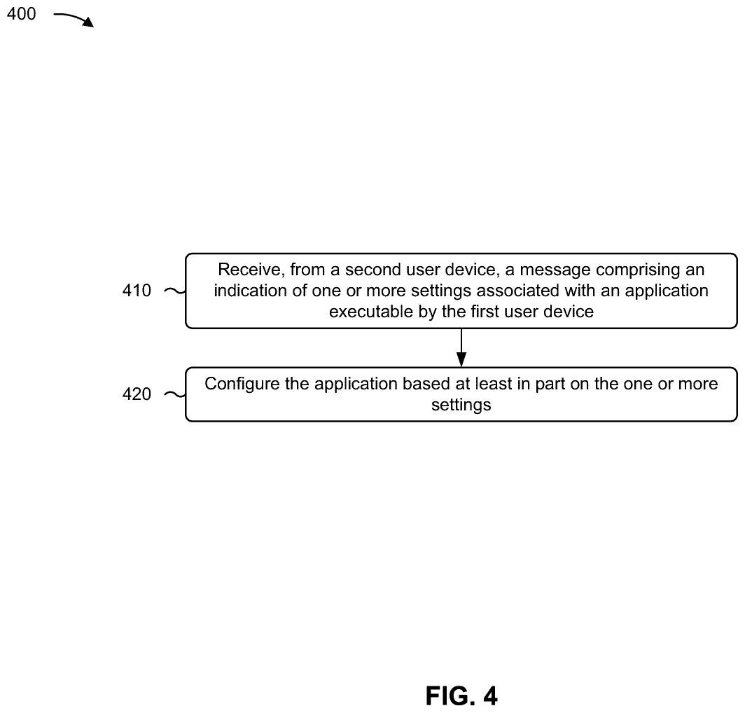

FIG. 4 is a flowchart of an example process 400 associated with application setting. In some implementations, one or more process blocks of FIG. 4 may be performed by a first user device (e.g., the first user device described in connection with FIGS. 1A-1F). In some implementations, one or more process blocks of FIG. 4 may be performed by another device or a group of devices separate from or including the first user device, such as a second user device (e.g., the second user device described in connection with FIGS. 1A-1F). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving, from a second user device, a message comprising an indication of one or more settings associated with an application executable by the first user device (block 410). For example, the first user device may receive, from a second user device, a message comprising an indication of one or more settings associated with an application executable by the first user device, as described above.

In some implementations, receiving the message comprises one or more of receiving the message via a server device, or receiving the message via a direct communication link with the second user device. In some implementations, process 400 includes transmitting a request for the indication of the one or more settings, wherein receiving the message is based on transmitting the request. In some implementations, the message comprises one or more of a short message service (SMS)-based message, a multimedia messaging service (MMS)-based message, or a rich text format (RTF)-based message.

In some implementations, the one or more settings comprise one or more of security settings, privacy settings, size settings, color settings, brightness settings, font size settings, accessibility settings, or content settings. In some implementations, the one or more settings comprise non-secure application settings. The settings mentioned above may be based on the first user device (e.g., may depend on capabilities of the first user device) or based on the second user device.

As further shown in FIG. 4, process 400 may include configuring the application based on the one or more settings (block 420). For example, the first user device may configure the application based on the one or more settings, as described above.

Process 400 may include additional implementations, such as any single implementation or any combination of implementations described below and/or in connection with one or more other processes described elsewhere herein.

In some implementations, process 400 includes establishing a decoding key associated with the message, and decoding, before configuring the application, the message using the decoding key. In some implementations, process 400 includes one or more of verifying that the message is from the second user device, decoding the message, extracting a public key from the message, extracting the indication of the one or more settings, or decrypting the message using the public key. In some implementations, the indication comprises one or more of an indication of a webpage that indicates the one or more settings, an encoded indication of the one or more settings, or an encrypted indication of the one or more settings.

In some implementations, process 400 includes receiving user input to install the application, and installing the application before configuring the application based on the one or more settings. In some implementations, process 400 includes receiving, from the second user device, an additional message comprising an additional indication of an update to the one or more settings.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a first user device, the method comprising:
receiving, from a second user device, a message comprising an indication of one or more settings associated with an application executable by the first user device; and
configuring the application based on the one or more settings.

2. The method of claim 1, further comprising:
transmitting a request for the indication of the one or more settings,
wherein receiving the message is based on transmitting the request.

3. The method of claim 1, wherein the message comprises one or more of:
a short message service (SMS)-based message, or
a multimedia messaging service (MMS)-based message.

4. The method of claim 1, further comprising:
establishing a decoding key associated with the message; and
decoding, before configuring the application, the message using the decoding key.

5. The method of claim 1, further comprising one or more of:
verifying that the message is from the second user device,
decoding the message;
extracting a public key from the message;
extracting the indication of the one or more settings; or
decrypting the message using the public key.

6. The method of claim 1, wherein the indication comprises one or more of:
an indication of a webpage that indicates the one or more settings,
an encoded indication of the one or more settings, or
an encrypted indication of the one or more settings.

7. The method of claim 1, further comprising:
receiving user input to install the application; and
installing the application before configuring the application based on the one or more settings.

8. The method of claim 1, wherein the one or more settings comprise one or more of:
security settings,
privacy settings,
font size settings,
color settings,
brightness settings,
accessibility settings, or
content settings.

9. The method of claim 1, wherein the one or more settings comprise non-secure application settings.

10. The method of claim 1, wherein receiving the message comprises one or more of:
receiving the message via a server device; or
receiving the message via a direct communication link with the second user device.

11. The method of claim 1, further comprising:
receiving, from the second user device, an additional message comprising an additional indication of an update to the one or more settings.

12. A computer program product comprising:
one or more computer readable storage media, and program instructions collectively stored on the one or more computer readable storage media, the program instructions comprising:
program instructions to receive, at a first user device and from a second user device, a short message service (SMS)-based message comprising an indication of one or more settings associated with an application executable by the first user device,
the SMS-based message being secured using a security key associated with the second user device; and
program instructions to configure the application based on the one or more settings.

13. The computer program product of claim 12, wherein the program instructions comprise program instructions to transmit a request for the indication of the one or more settings,
wherein the SMS-based message is received based on transmission of the request.

14. The computer program product of claim 12, wherein the program instructions comprise:
program instructions to decode, before configuring the application, the message using a decoding key associated with the security key.

15. The computer program product of claim 12, wherein the program instructions comprise program instructions to perform one or more of:
verification that the message is from the second user device,
decoding of the message;
extraction of a public key from the message;
extraction of the indication of the one or more settings; or
decryption of the message using the public key.

16. A system comprising:
one or more devices configured to:
receive, at a first user device and from a second user device, a message comprising an indication of one or more settings associated with an application executable by the first user device,
wherein the message comprises a hash of the one or more settings that is signed with a private key associated with the second user device;
validate that the message is associated with the second user device; and
configure, at the first user device, the application based on the one or more settings.

17. The system of claim 16, wherein the indication comprises one or more of:
an indication of a webpage that indicates the one or more settings,
an encoded indication of the one or more settings, or
an encrypted indication of the one or more settings.

18. The system of claim 16, wherein the one or more devices are further configured to:
receive user input to install the application; and
install the application before configuring the application based on the one or more settings.

19. The system of claim 16, wherein the one or more settings comprise non-secure application settings.

20. The system of claim 16, wherein, to receive the message, the one or more devices are further configured to:
receive the message via a server device; or
receive the message via a direct communication link with the second user device.
